(19) United States
(12) Patent Application Publication
(10) Pub. No.: US 2008/0204937 A1
(43) Pub. Date: Aug. 28, 2008

(54) Magnetic recording medium, manufacturing method thereof and magnetic recording apparatus using magnetic recording medium

(75) Inventors: Yuuki Yoshida, Higashine (JP); Jun Taguchi, Higashine (JP); Kazuhisa Shida, Higashine (JP); Noriyuki Asakura, Higashine (JP); Akira Kikuchi, Higashine (JP)

Correspondence Address: GREER, BURNS & CRAIN, 300 S WACKER DR, 25TH FLOOR, CHICAGO, IL, 60606, US

(73) Assignee: Fujitsu limited, Kawasaki-shi (JP)

(21) Appl. No.: 12/002,555

(22) Filed: Dec. 18, 2007

(30) Foreign Application Priority Data
Feb. 23, 2007 (JP) 2007-43580

(51) Int. Cl. G11B 5/60; G11B 5/33; G11B 21/20; B05D 5/12

(52) U.S. Cl. 360/234.4; 428/800; 427/131

(57) ABSTRACT

This magnetic recording medium comprising at least a non-magnetic underlayer on a non-magnetic substrate, a first recording magnetic layer on the non-magnetic underlayer, a second recording magnetic layer on the first recording magnetic layer, and a third recording magnetic layer on the second recording magnetic layer. The first recording magnetic layer, the second recording magnetic layer and the third recording magnetic layer are made of a CoCrPtB alloy. The second recording magnetic layer has a smaller Cr content and a greater B content than the first recording magnetic layer, and the third recording magnetic layer has a smaller Cr content and a greater B content than the first recording magnetic layer and a smaller Pt content than the second recording magnetic layer. The magnetic recording medium according to the present invention can obtain high output medium characteristic with low noise and excellent written performance.

The present invention relates to magnetic recording medium, and more specifically, to a structure of magnetic recording medium featuring low noise and high output characteristics.

### BACKGROUND OF THE INVENTION

Digitization and computerization in recent years require large-capacity recording apparatuses. Therefore, recording density of magnetic recording apparatuses such as magnetic hard disk drives (HDD) is rapidly increasing. This entails a demand for magnetic recording medium having low noise and high output characteristics. However, conventional magnetic recording medium have a tendency that their output characteristic deteriorates as their noise characteristic is improved. Therefore, there is a demand for magnetic recording mediums which have an excellent noise characteristic and output characteristic.

A conventional longitudinal magnetic recording medium uses a Co alloy magnetic layer which is a high saturated magnetization (hereinafter, referred to as “Ms”) material for a recording layer. This is because high output is obtained. Various elements are added to the Co alloy magnetic layer. This is intended to further improve performance characteristics and realize high recording density.

Addition of Cr mainly reduces intergranular interaction. A decline of the intergranular interaction reduces noise. The magnetic recording medium then has high resolution. Furthermore, addition of Pt increases an anisotropy field (Hk). The magnetic recording medium then has high resolution. Furthermore, addition of B makes crystal grains finer. Finer crystal grains result in reduced noise. The magnetic recording medium then has high resolution. However, excessive addition of Cr causes Ms to decrease. The reduction of Ms causes read output to decrease. Therefore, the conventional magnetic recording medium needs to adjust the amount of Cr added according to the read sensitivity of the head.

However, U.S. Pat. No. 7,049,013 discloses a multilayered magnetic recording medium. The magnetic layer of this magnetic recording medium is composed of a lower layer having a high Cr composition (hereinafter, referred to as a “high Cr magnetic layer”) and a upper layer having a low Cr composition (hereinafter, referred to as a “low Cr magnetic layer”). This magnetic recording medium is low noise and also high output.

FIG. 1 shows a cross-sectional view of a conventional magnetic recording medium having two recording magnetic layers. This has a structure with an underlayer 2, a first recording magnetic layer 3, a second recording magnetic layer 4, a protective layer 5 and a lubrication layer 6 sequentially multilayered on a substrate 1. Adopting a high Cr magnetic layer for the first recording magnetic layer 3 reduces intergranular interaction. The magnetic recording medium then becomes low noise. A low Cr magnetic layer is adopted for the second recording magnetic layer 4. The read output of the magnetic recording medium then increases. That is, the function of the recording magnetic layer is separated and low noise and high output characteristics are realized.

This multilayered structure (mainly, two-layered structure) constitutes a current mainstream technology of longitudinal magnetic recording medium for hard disks. When actually applying this multilayering technology, a greater amount of B is added to the low Cr magnetic layer (the upper layer) than the high Cr magnetic layer (the lower layer). This is intended to maintain a good noise characteristic.

In this way, (1) multilayering the Co alloy recording layer, (2) making the Cr content on the lower layer greater than that on the upper layer and (3) making the B content on the upper layer greater than that on the lower layer allow the magnetic recording medium to meet high recording density requirements. However, an investigation result proved that when the B content on the upper layer increased, crystal orientation on the upper layer (longitudinal orientation of the c-axis of the Co alloy crystal) deteriorated.

FIG. 2 shows, a full width at half maximum (a) of a Co(110) rocking curve of a magnetic layer when the magnetic layer is formed as a single layer and the B content of the magnetic layer is changed, and a full width at half maximum (b) of a Co(110) rocking curve of the magnetic layer when the magnetic layer is formed of two layers and the B content on the lower layer of the magnetic layer is fixed to 6 at. % and the B content on the upper layer of the magnetic layer is changed. Here, it is demonstrated that the smaller the full width at half maximum of the Co(110) rocking curve, the better is the orientation. It is understandable that when the magnetic layer is formed of a single layer, the crystal orientation noticeably degrades as the B content increases. On the other hand, when the magnetic layer is formed of two layers, since a certain degree of orientation is determined by the lower layer of the magnetic layer, and therefore the variation of the crystal orientation is smaller than when the magnetic layer is formed of a single layer. However, even when the magnetic layer is formed of two layers, the orientation degrades with the increase of the B content. This indicates that a noise reduction achieved by increasing the B content and improving the fine structure of crystal grains has a trade-off relationship with a noise reduction achieved by improving longitudinal orientation.

On the other hand, the Pt content of the low Cr magnetic layer (the upper layer) is adjusted according to the writing performance of the head. This is intended, for example, to obtain a desired magnetic characteristic of coercive force Hc or the like. However, an investigation result showed that when the Pt content was increased, the longitudinal orientation of the magnetic layer (the upper layer) also improved. FIG. 3 shows a result of an investigation of a full width at half maximum of a Co(110) rocking curve with respect to the Pt content in the low Cr magnetic layer. A case (c) where the low Cr magnetic layer was placed on the high Cr magnetic layer and a case (d) where no high Cr magnetic layer was formed and only the low Cr magnetic layer was formed were examined. Both cases show that the orientation is improved up to addition of 13 to 15 at. %.

The longitudinal orientation degrades with an increase of the B content but improves with an increase of the Pt content. This is because the writing performance of the head has been improved year after year and increasing medium Hc (or Hk) has also successfully increased the Pt content at the same time.

However, the writing performance of the head is substantially reaching its physical limit recently. This is because the writing performance is substantially determined by physical and structural factors such as saturated magnetization and dimension of the write magnetic pole. Therefore, it is difficult to further increase the Pt content of the magnetic layer (the upper layer) of the medium. That is, it is becoming impossible to maintain longitudinal orientation and achieve low noise, and achieve good writing performance at the same time.

Therefore, it is an object of the present invention to provide a high output magnetic recording medium capable of achieving both a fine structure and longitudinal orientation at the same time to reduce noise and also realizing good written performance.

### SUMMARY OF THE INVENTION

In accordance with an aspect of an embodiment, a magnetic recording medium comprising at least a non-magnetic underlayer on a non-magnetic substrate, a first recording magnetic layer on the non-magnetic underlayer, a second recording magnetic layer on the first recording magnetic layer, and a third recording magnetic layer on the second recording magnetic layer. The first recording magnetic layer, the second recording magnetic layer and the third recording magnetic layer are made of a CoCrPtB alloy. The second recording magnetic layer has a smaller Cr content and a greater B content than the first recording magnetic layer, and the third recording magnetic layer has a smaller Cr content and a greater B content than the first recording magnetic layer and a smaller Pt content than the second recording magnetic layer.

In addition, in accordance with an aspect of an embodiment, a magnetic recording apparatus includes a magnetic recording medium, a magnetic recording head for writing information to be recorded into the magnetic recording medium, a magnetic reading head for reading the recorded information from the magnetic recording medium, a flexible suspension joined to the magnetic recording head and the magnetic reading head, a pivotable actuator arm which fixes an end of the suspension, and a transmission/detection circuit apparatus electrically connected to the magnetic recording head and the magnetic reading head through an insulated conductor on the suspension and the actuator arm for transmitting/detecting an electric signal to record information into the magnetic recording medium and read the information recorded in the magnetic recording medium. The magnetic recording medium has at least a non-magnetic underlayer, a first recording magnetic layer, a second recording magnetic layer and a third recording magnetic layer. The first recording magnetic layer, the second recording magnetic layer and the third recording magnetic layer are made of a CoCrPtB alloy. The second recording magnetic layer has a smaller Cr content and a greater B content than the first recording magnetic layer, and the third recording magnetic layer has a smaller Cr content and a greater B content than the first recording magnetic layer and a smaller Pt content than the second recording magnetic layer.

### BRIEF DESCRIPTION OF THE DRAWINGS

The present invention will be explained with reference to the accompanying drawings.

FIG. 1 shows a cross-sectional view of a conventional magnetic recording medium with two recording magnetic layers;

FIG. 2 shows crystal orientation of a magnetic layer when a B content is changed;

FIG. 3 shows a relationship between the amount of Pt added in a magnetic layer of a low Cr composition and longitudinal orientation;

FIG. 4 shows the configuration of a first embodiment of a magnetic recording medium according to the present invention;

FIG. 5 shows the configuration of a second embodiment of a magnetic recording medium according to the present invention;

FIG. 6 shows an evaluation result of examples according to the present invention and comparative examples;

FIG. 7 is a perspective view of a magnetic recording apparatus using the magnetic recording medium of the present invention;

FIG. 8A is a schematic view showing a positional relationship of a suspension, a head slider, a magnetic head and the magnetic recording medium of the present invention; and

FIG. 8B is a schematic view showing the structure of the recording magnetic head and the read magnetic head of the magnetic head shown in FIG. 8A.

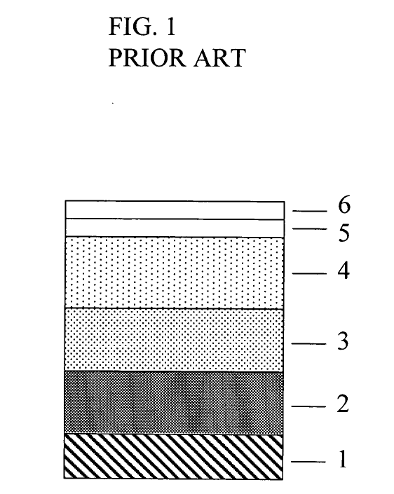

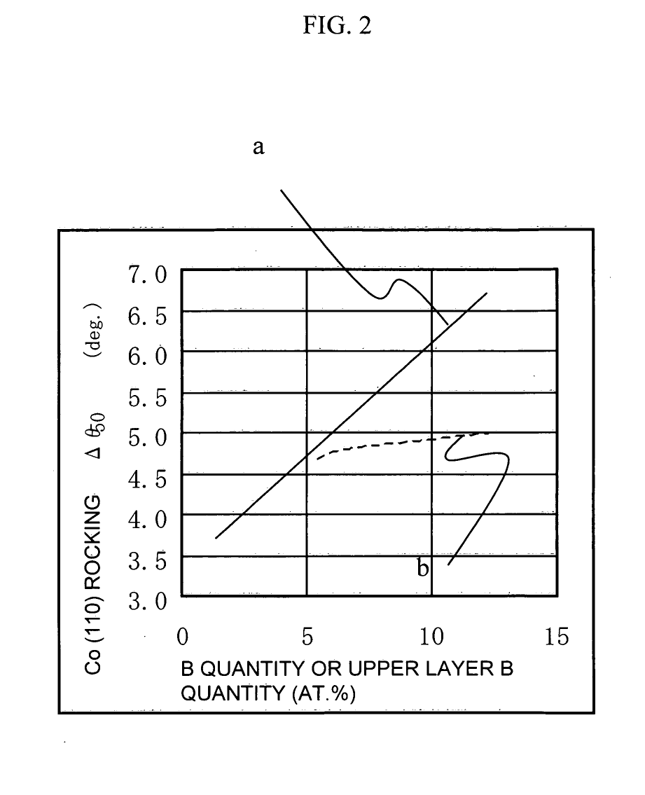

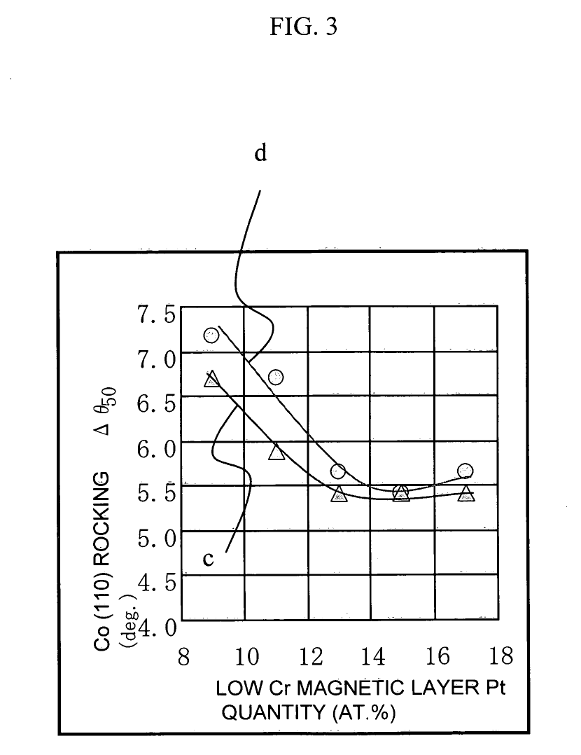

### DETAILED DESCRIPTION

Hereinafter, embodiments of the present invention will be explained in detail based on the attached drawings.

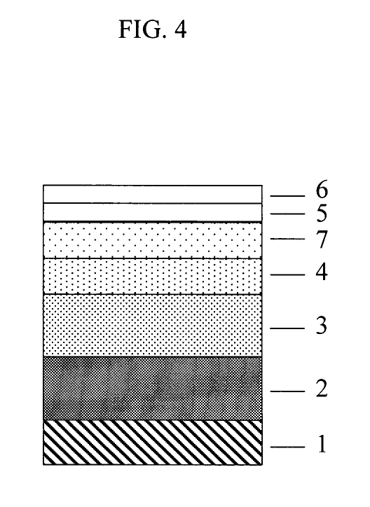

FIG. 4 shows the configuration of a first embodiment of the magnetic recording medium according to the present invention. FIG. 4 is a cross-sectional view of the magnetic recording medium according to the present invention. For the magnetic recording medium, for example, an NiP-coated Al substrate 1 is subjected to texturing processing in the circumferential direction using a slurry liquid containing diamond abrasive grains. After a cleaning process, an underlayer 2, a first recording magnetic layer 3, a second recording magnetic layer 4, a third recording magnetic layer 7, a protective layer 5 and a lubrication layer 6 are sequentially multilayered on a heated substrate. Glass may be used for the substrate 1. In the case of a glass substrate, a seed layer of CrTi, CrTa, CrNb, NiTa, NiNb or the like may also be arranged on the substrate. This is intended to obtain good crystallinity of the underlayer 2.

The underlayer 2, magnetic layers 3, 4 and 7 are formed using a sputtering method and the protective layer 5 is formed using a CVD method inside the same coating equipment which is kept to vacuum. After that, the surface of the protective layer 5 is subjected to nitriding or ozone water treatment and the fluorine-based lubrication layer 6 is then applied thereto. Tape-varnishing is applied to remove burrs and extraneous matter from the surface. In this case, the substrate temperature at the time of sputtering film formation is preferably 180° C. to 300° C.

The appropriate thickness of Cr of the underlayer 2 is 1 to 10 nm. Furthermore, the appropriate thickness of the first recording magnetic layer 3 is 5 to 15 nm and more preferably 8 to 12 nm. The appropriate total film thickness of the second recording magnetic layer 4 and third recording magnetic layer 7 is 5 to 15 nm and more preferably 6 to 11 nm. Especially, the appropriate film thickness of each of the second recording magnetic layer 4 and the third recording magnetic layer 7 is 2 to 10 nm. However, the film thickness ratio of the two layers varies depending on each Pt composition and writing performance of the head.

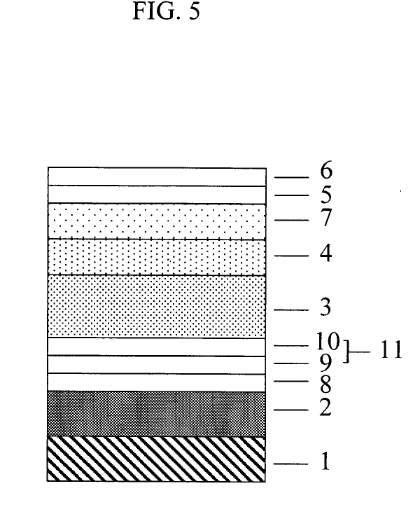

Next, FIG. 5 shows the configuration of a second embodiment of a magnetic recording medium according to the present invention. The magnetic recording medium of the second embodiment will be compared with the magnetic recording medium of the first embodiment. The underlayer on the substrate 1 made of Al has a two-layer structure. This two-layer structure is made up of an underlayer 2 and a lattice matching underlayer 8. The underlayer 2 is 1 to 6 nm made of Cr and the lattice matching underlayer 8 is 1 to 4 nm made of CrMo whose crystal lattice is made greater in size than the underlayer 2. This is intended to maintain matching with the lattice size of the Co alloy magnetic layer whose crystal lattice is made greater in size by adding various elements. This allows the crystalline structure of the magnetic layer to be controlled satisfactorily. An intermediate layer of an hcp structure may also be arranged between CrMo and the first recording magnetic layer 3. This is intended to improve the crystalline structure, diameter of crystal grains and orientation of the initial layer of the first recording magnetic layer by arranging the intermediate layer having an hcp structure between the underlayer 2 and the first recording magnetic layer 3.

Furthermore, the medium of a reduced grain size with a high B composition has a problem with degradation of thermal stability. As shown in FIG. 5, this medium has a thermally stabilizing layer 11 composed of a CoCrTa layer of 1 to 4 nm and a Ru layer of 0.5 to 1 nm between the first recording magnetic layer 3 and the lattice matching underlayer 8. The thermally stabilizing layer 11 is composed of a thermally stabilizing magnetic layer 9 and a non-magnetic exchange coupling layer 10. The product of the film thickness and the saturated magnetization of the thermally stabilizing magnetic layer 9 is smaller than that of the first recording magnetic layer 3. The non-magnetic exchange coupling layer 10 is the layer for the thermally stabilizing magnetic layer 9 and the first recording magnetic layer 3 to antiferromagnetically couple with each other.

The characteristic of the magnetic recording medium when the compositions of the first to third recording magnetic layers 3, 4 and 7 in the above described example are changed will be explained. The first recording magnetic layer 3 is a high Cr CoCrPtB material with a Cr content of 25 at. %. The second recording magnetic layer 4 and the third recording magnetic layer 7 are low Cr CoCrPtB materials with a Cr content of 12 at. % and a B content of 10 at. %. The Pt content of the second recording magnetic layer 4 is 13 to 17 at. %. The Pt content of the third recording magnetic layer 7 was made to vary between 9 to 13 at. %. A medium in a conventional configuration with the low Cr magnetic layer not divided into two layers was also prepared as a comparative example. The Pt content of the second recording magnetic layer 4 in the comparative example is 9 to 17 at. %. The third recording magnetic layer 7 in the comparative example was not formed.

Each sample prepared was evaluated using a spin stand. The head is a GMR head for 75 Gb/inch2 class for a HDD for a server. Medium noise was measured at a linear recording density of 434 kFCI. This measured value was normalized with the output measured at a low frequency of 109 kFCI. Furthermore, the written performance was evaluated. Suppose the read output when a write is performed at a low frequency of 109 kFCI is V1. Suppose the read output of the low frequency component which remains after an overwrite is performed at a high frequency of 868 kFCI is V2. The ratio of V2 to V1 was calculated and used as an index.

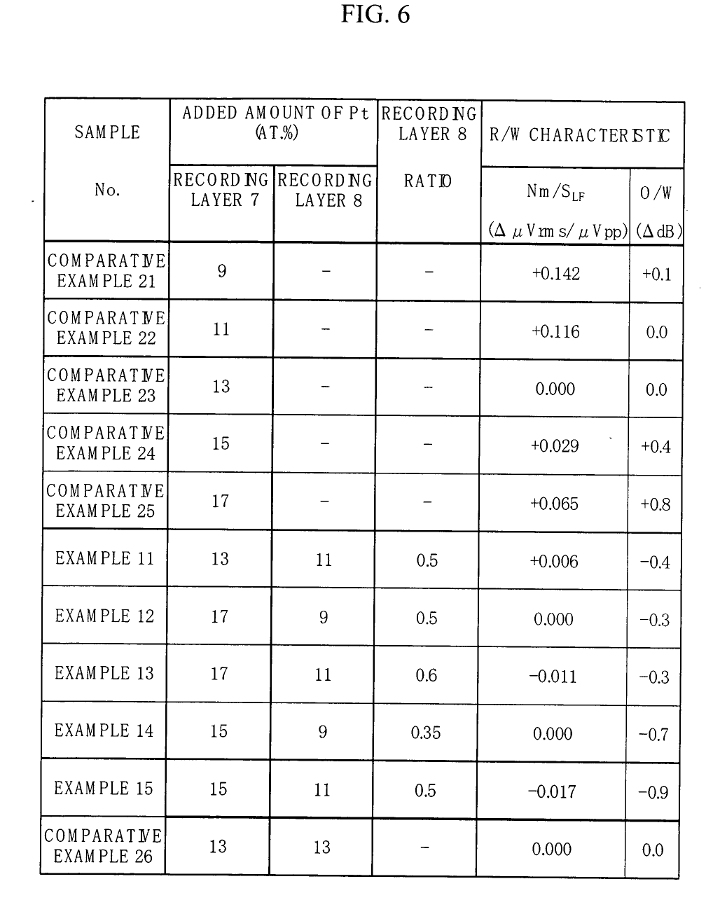

FIG. 6 shows the result of evaluating examples 11 to 15 and comparative examples 21 to 26 under the above described condition. “Nm/SLF” denotes normalized noise. “O/W” denotes written performance. All values show differences from comparative example 23 and the smaller the value the better. The optimum Pt content when the third recording magnetic layer 8 is not formed (when the low Cr magnetic layer is formed of a single layer) (comparative examples 21 to 25) is determined by the writing performance of the head. In the case of the head used in this example, noise becomes a minimum at a Pt content of 13 at. % (comparative example 23). The Pt content of 13 at. % is optimum.

On the other hand, examples 12 to 15 will be compared with comparative example 23 which has the best characteristic among the comparative examples. Both noise and written performance are improved and those values become small. As for example 11, noise is increased but written performance is improved. For the head used in this example, when the low Cr magnetic layer is a single layer, there will be no problem even if Pt is increased up to 13 at. %. This indicates that there are few merits in the combination of two layers in compositions of 13 at. % and below. However, in the case of a combination with the head of low writing performance, adopting a two-layer structure, one of two-layers is having more than a Pt content at which a good writing characteristic is obtained in a single layer and the other is having less than the Pt content, of a low Cr magnetic layer makes it possible to achieve both noise reduction and good written performance.

The magnetic recording medium according to the present invention can obtain high output medium characteristic with low noise and excellent written performance. It is possible to provide a high density magnetic recording medium and a large-capacity magnetic recording apparatus.

Comparative example 26 is a sample equivalent to comparative example 23. However, comparative example 26 is a sample for which both the second recording magnetic layer 7 and third recording magnetic layer 8 were formed of the same material of Pt of 13 at. % in two steps. It was possible to confirm that comparative example 26 had the characteristic equivalent to that of comparative example 23 regardless of the film thickness ratio between the second recording magnetic layer 4 and the third recording magnetic layer 7.

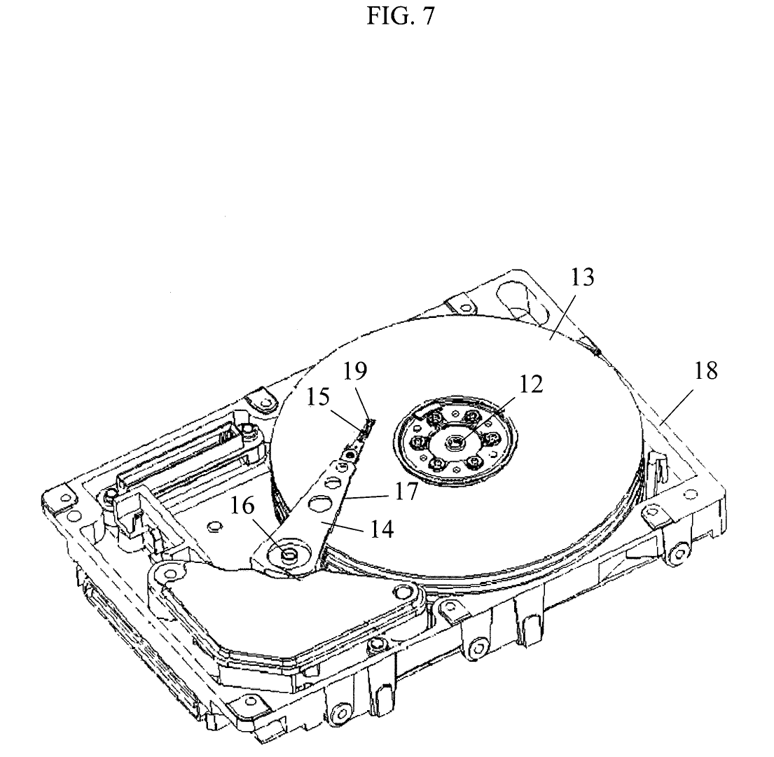

A magnetic recording apparatus mounted with the magnetic recording medium will be explained in brief. FIG. 7 is a perspective view of a magnetic recording apparatus using the magnetic recording medium of this embodiment. The magnetic recording medium 13 contains magnetic information. The magnetic recording medium 13 rotates at high speed with a spindle motor 12. An actuator arm 14 is provided with a suspension 15 made of flexible stainless steel. Furthermore, the actuator arm 14 is pivotably fixed to a housing 18 through a shaft 16. The actuator arm 14 moves in a quasi radial direction of the magnetic recording medium 13. In this case, a head slider 19 attached to the suspension 15 moves and records/reads information on a predetermined track of the magnetic recording medium 13.

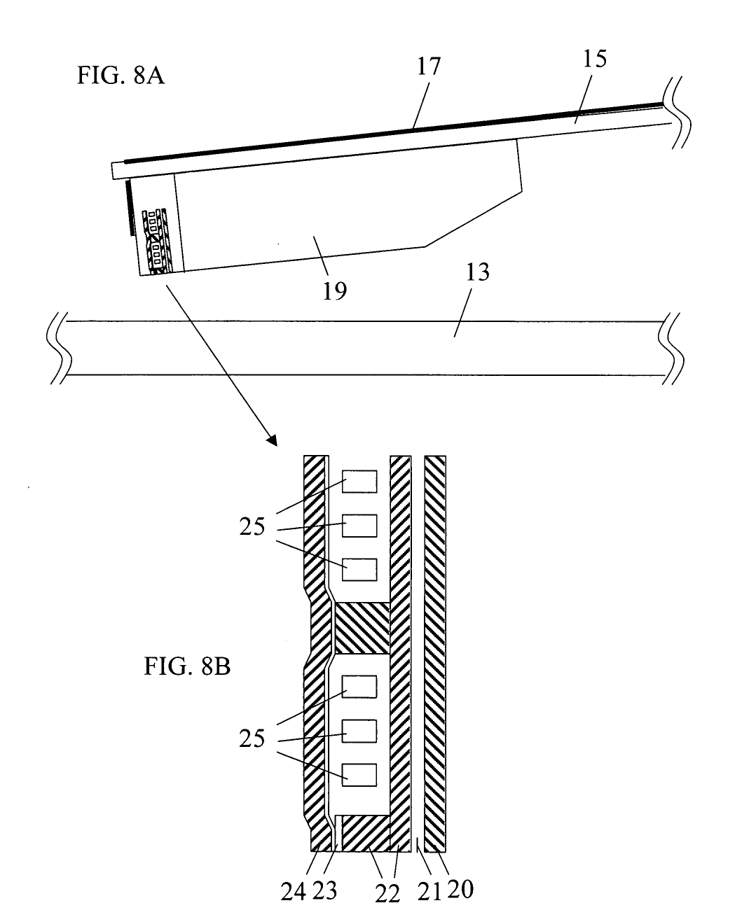

A transmission/detection circuit apparatus to send/detect a recording/read signal is fixed in the housing 18. The transmission circuit apparatus passes a recording current to a coil 25 (FIG. 8B) in a recording magnetic head. The transmission circuit apparatus then generates a magnetic field between an upper magnetic pole 24 and a lower magnetic pole 22 and records magnetic information into the medium. On the other hand, the detection circuit apparatus passes a sense current to a magnetic resistance effect element in a read magnetic head 21. The detection circuit apparatus then measures a voltage variation of the magnetic resistance effect element. It then detects a variation of the resistance value and reconstructs information from the medium.

FIG. 8A shows a schematic view showing a positional relationship between the suspension 15, the head slider 19 and the recording/read magnetic head shown in FIG. 7 and the magnetic recording medium 13 of this embodiment shown in FIG. 4 and FIG. 5. The head slider 19 is attached to the suspension 15 under the suspension 15 and constitutes a head suspension assembly. The magnetic recording medium 13 rotates at high speed. It draws in the air between the head slider 19 and the magnetic recording medium 13. The pressure thereof causes the head slider 19 to float. The recording/read magnetic head attached to the tip of the head slider 19 is electrically connected to the transmission/detection circuit apparatus through an insulated conductive wire 17 on the suspension 15 and the actuator arm 14.

FIG. 8B shows the structure of the recording magnetic head and the read magnetic head of the magnetic head shown in FIG. 8A. The read magnetic head 21 has a structure interposed between a lower shield 20 and an upper shield 22. The read magnetic head 21 is arranged adjacent to the recording magnetic head. The recording magnetic head is composed of the lower magnetic pole 22 and an upper magnetic pole 24 arranged on both sides of a write gap 23, and a recording coil 25. The lower magnetic pole 22 also serves as the upper shield.

The magnetic recording medium 13 of this embodiment shown in FIG. 4 and FIG. 5 displays excellent written performance for a magnetic field which corresponds to an electric signal sent from a transmission circuit apparatus. This magnetic field is a micro magnetic field from the recording magnetic head used to realize high density. Furthermore, a magnetic field is generated from the magnetic recording medium 13 according to the recorded magnetic information. When the medium magnetic field is read by the read magnetic head 21, a low noise and high output signal can be detected through the detection circuit apparatus through a conductor. Therefore, it is possible to provide a large-capacity magnetic recording apparatus.

What is claimed is:

1. A magnetic recording medium comprising at least:
a non-magnetic underlayer on a non-magnetic substrate;
a first recording magnetic layer on the non-magnetic underlayer;
a second recording magnetic layer on the first recording magnetic layer; and
a third recording magnetic layer on the second recording magnetic layer,
wherein the first recording magnetic layer, the second recording magnetic layer and the third recording magnetic layer are made of a CoCrPtB alloy,
the second recording magnetic layer has a smaller Cr content and a greater B content than the first recording magnetic layer, and
the third recording magnetic layer has a smaller Cr content and a greater B content than the first recording magnetic layer and a smaller Pt content than the second recording magnetic layer.

2. The magnetic recording medium according to claim 1, wherein the Pt content of the second recording magnetic layer is greater than the Pt content corresponding to a minimum noise value when the composition of the second recording magnetic layer is identical to that of the third recording magnetic layer, and
the Pt content of the third recording magnetic layer is equal to or smaller than the Pt content corresponding to a minimum noise value when the composition of the second recording magnetic layer is identical to that of the third recording magnetic layer.

3. The magnetic recording medium according to claim 1, wherein the Pt content of the second recording magnetic layer is greater than 13 at. %, and
the Pt content of the third recording magnetic layer is equal to or smaller than 13 at. %.

4. The magnetic recording medium according to claim 1, wherein the B content of the second recording magnetic layer is equal to or greater than 10 at. %.

5. The magnetic recording medium according to claim 2, wherein the B content of the second recording magnetic layer is equal to or greater than 10 at. %.

6. The magnetic recording medium according to claim 3, wherein the B content of the second recording magnetic layer is equal to or greater than 10 at. %.

7. The magnetic recording medium according to claim 1, wherein the B content of the third recording magnetic layer is equal to or greater than 10 at. %.

8. The magnetic recording medium according to claim 2, wherein the B content of the third recording magnetic layer is equal to or greater than 10 at. %.

9. The magnetic recording medium according to claim 3, wherein the B content of the third recording magnetic layer is equal to or greater than 10 at. %.

10. The magnetic recording medium according to claim 1, wherein the composition ratio of the second recording magnetic layer is Co_{78-X}Cr₁₂Pt_{X}B₁₀(13<X≦17 at. %) , and the composition ratio of the third recording magnetic layer is Co_{78-X}Cr₁₂Pt_{X}B₁₀(9≦X≦13 at. %).

11. The magnetic recording medium according to claim 2, wherein the composition ratio of the second recording magnetic layer is Co_{78-X}Cr₁₂Pt_{X}B₁₀(133<X≦17 at. %) , and
the composition ratio of the third recording magnetic layer is Co_{78-X}Cr₁₂Pt_{X}B₁₀(9≦X≦13 at. %).

12. The magnetic recording medium according to claim 3, wherein the composition ratio of the second recording magnetic layer is Co_{78-X}Cr₁₂Pt_{X}B₁₀(13<X≦17 at. %), and
the composition ratio of the third recording magnetic layer is Co_{78-X}Cr₁₂Pt_{X}B₁₀(9≦X≦13 at. %)

13. A method of manufacturing the magnetic recording medium according to claim 1, sequentially multilayering the first recording magnetic layer, the second recording magnetic layer and the third recording magnetic layer inside a sputtering apparatus.

14. A method of manufacturing the magnetic recording medium according to claim 2, sequentially multilayering the first recording magnetic layer, the second recording magnetic layer and the third recording magnetic layer inside a sputtering apparatus.

15. A method of manufacturing the magnetic recording medium according to claim 3, sequentially multilayering the first recording magnetic layer, the second recording magnetic layer and the third recording magnetic layer inside a sputtering apparatus.

16. A magnetic recording apparatus comprising:
a magnetic recording medium;
a magnetic recording head for writing information to be recorded into the magnetic recording medium;
a magnetic reading head for reading the recorded information from the magnetic recording medium;
a flexible suspension joined to the magnetic recording head and the magnetic reading head;
a pivotable actuator arm which fixes an end of the suspension; and
a transmission/detection circuit apparatus electrically connected to the magnetic recording head and the magnetic reading head through an insulated conductor on the suspension and the actuator arm for transmitting/detecting an electric signal to record information into the magnetic recording medium and read the information recorded in the magnetic recording medium,
1wherein the magnetic recording medium comprises at least a non-magnetic underlayer, a first recording magnetic layer, a second recording magnetic layer and a third recording magnetic layer,
the first recording magnetic layer, the second recording magnetic layer and the third recording magnetic layer are made of a CoCrPtB alloy;
the second recording magnetic layer has a smaller Cr content and a greater B content than the first recording magnetic layer, and
the third recording magnetic layer has a smaller Cr content and a greater B content than the first recording magnetic layer and a smaller Pt content than the second recording magnetic layer.
